(19) United States
(12) Patent Application Publication
(10) Pub. No.: US 2023/0247097 A1
(43) Pub. Date: Aug. 3, 2023

(54) SPLIT INPUT AND OUTPUT (IO) FOR MANAGING INTERACTIVE SESSIONS BETWEEN USERS

(71) Applicant: AT&T Intellectual Property I, L.P., Atlanta, GA (US)

(72) Inventors: Lars Benjamin Johnson, Brooklyn, NY (US); Mikhail Istomin, Brooklyn, NY (US); Rachel Rosencrantz, Seattle, WA (US); Wei Wang, Harrison, NJ (US)

(73) Assignee: AT&T Intellectual Property I, L.P., Atlanta, GA (US)

(21) Appl. No.: 17/591,635

(22) Filed: Feb. 3, 2022

(51) Int. Cl. H04L 67/141; H04L 67/143; H04L 67/146; H04L 67/306

(52) U.S. Cl. CPC H04L 67/141; H04L 67/143; H04L 67/146; H04L 67/306

(57) ABSTRACT

Aspects of the subject disclosure may include, for example, receiving a request to initiate an interactive session involving a first user device and a second user device, initiating the interactive session, performing a split of inputs or outputs by determining a first set of inputs or outputs for the first user device and a second set of inputs or outputs for the second user device, such that first data in the interactive session that is permitted to be outputted only to the first user device is accessible to the first user device but not to the second user device and such that second data that is permitted to be outputted only to the second user device is accessible to the second user device but not to the first user device, and facilitating the interactive session based on the split of inputs or outputs. Other embodiments are disclosed.

### FIELD OF THE DISCLOSURE

The subject disclosure relates to split input and output (IO) system(s) for facilitating interactive sessions between users.

### BACKGROUND

Advances in mobile device technology have positively transformed society in a variety of ways. However, the ubiquity and usefulness of these devices has not come without challenges. As malicious actors are constantly employing social engineering tactics and exploiting system loopholes to gain access to sensitive information, data security, in particular, has been a major issue for both organizations and users alike.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIG. 2B is a block diagram illustrating an example, non-limiting embodiment of a system functioning within, or operatively overlaid upon, the communications network of FIG. 1 in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

In certain settings, such as engagements between organizations (e.g., businesses) and its users/customers, there may be situations where, for example, a customer needs to input personal data into the business's systems/devices or needs to verify the customer's own information in order to facilitate the provision of services or other transactions. As users become more inclined to trust others less with their personal data, however, they may be hesitant to input their information into others' devices. Indeed, in a customer care setting, whether conducted remotely or in-person (e.g., on customer premises or at a store location), a customer representative, such as a technician or store clerk, may not have a need to know the customer's personal information, such as their full name, phone number, e-mail address, account-related financial data, and so on. Yet, as part of a typical service-related engagement, a representative may unfortunately gain access to some or all of this information.

Further, apart from data security, it can also be useful, in other settings, to withhold certain information from one or more of the parties as part of a broader experience or context. For instance, in an online learning arrangement between an instructor and a student, it can be helpful to reveal quiz answers to the instructor and yet prevent the answers from being shown to the student during a quiz.

The subject disclosure describes, among other things, illustrative embodiments of a split input and output (IO) system that is capable of determining input(s) and/or output(s) for each of multiple (e.g., participant) user devices in an interactive session, and facilitating, and managing, the interactive session between the user devices based on the determined input(s) and/or output(s). In exemplary embodiments, the split IO system may include a backend (interface) system configured to determine the input(s) and/or output(s) for a given user device—e.g., by deciding which input(s) must (or are permitted) to be received from that user device and/or which output(s) must (or are permitted) to be provided to that user device-based upon predefined control data, artificial intelligence (AI) model(s), and/or user instruction(s).

As described herein, in one or more embodiments, such as in a case where certain information is (e.g., previously determined) to be accessible (e.g., only) to a particular participant in an interactive session, the backend system may be configured to enable one or more other participants to nevertheless access that information if the particular participant commands that the information be shared therewith.

Exemplary embodiments of the split IO system, described herein, can be applied in a variety of interactive settings involving two or more parties. For example, embodiments of the split IO system may be employed in a customer service setting (e.g., conducted remotely or in-person, such as at a store location or on the customer's premises), where the backend system facilitates an interactive session between a customer and an organization's customer representative via their respective user devices. Here, the backend system may, for instance, be configured to limit access by the customer representative's device to (e.g., only) the items of customer-related information that the customer representative needs to know, and may be configured to enable the customer (e.g., as part of what's required in the interaction in order to facilitate the provision of services) to provide inputs and/or verify the customer's personal information using the customer's own device. In a case where the organization may not wish certain business-related information to be revealed to the customer, the backend system may similarly restrict output of such information to the customer's device. This advantageously protects sensitive data from being revealed during user interactions, which improves overall data security and instills trust between the parties (particularly in situations where each of the parties may trust their own user device, but not necessarily the user device of the other party). Customer service can also be accelerated, enabling more customers to be serviced over time.

The split (or segregation) of input(s)/output(s), as described herein, can also be employed in a classroom setting (e.g., virtual or in-person), where the backend system facilitates an interactive session between an instructor and a student via their respective user devices. Here, the backend system may, for instance, be configured to restrict answer(s) to quiz problem(s) from being outputted to the student's device during a quiz and/or permit certain hint(s) to be provided to the student's device based on a command from the instructor. This enables the instructor to tailor questions to students as they assist the student through problem-solving.

One or more aspects of the subject disclosure include a device, comprising a processing system including a processor, and a memory that stores executable instructions that, when executed by the processing system, facilitate performance of operations. The operations can include receiving a request to initiate an interactive session, wherein the interactive session involves a first user device associated with a first user and a second user device associated with a second user. Further, the operations can include, responsive to the receiving the request, initiating the interactive session for the first user device and the second user device. Further, the operations can include performing a split of inputs or outputs for the interactive session by determining a first set of inputs or outputs for the first user device and a second set of inputs or outputs for the second user device, such that first data in the interactive session that is permitted to be outputted only to the first user device is accessible to the first user device but not to the second user device and such that second data that is permitted to be outputted only to the second user device is accessible to the second user device but not to the first user device. Further, the operations can include facilitating the interactive session between the first user device and the second user device based on the split of inputs or outputs.

One or more aspects of the subject disclosure include a non-transitory machine-readable medium, comprising executable instructions that, when executed by a processing system of a first user device including a processor, facilitate performance of operations. The operations can include transmitting a request to a backend system to participate in an interactive session, wherein the first user device is associated with a first user, and wherein the interactive session involves a second user device associated with a second user. Further, the operations can include accessing the interactive session based upon the transmission of the request. Further, the operations can include receiving first data from the backend system during the interactive session, wherein the backend system is configured to determine a first set of permissible inputs or outputs for the first user device and a second set of permissible inputs or outputs for the second user device, and wherein the receiving is in accordance with the backend system identifying, based on the first set of permissible inputs or outputs for the first user device, that the first user device is not restricted from accessing the first data.

One or more aspects of the subject disclosure include a method. The method can comprise obtaining, by a processing system including a processor, and from a first user device associated with a first user and a second user device associated with a second user, respective requests to access an interactive session. Further, the method can include, based upon the obtaining the respective requests, initiating, by the processing system, the interactive session for the first user device and the second user device. Further, the method can include identifying, by the processing system, a first set of inputs or outputs for the first user device, resulting in a first determined set of inputs or outputs, and identifying, by the processing system, a second set of inputs or outputs for the second user device, resulting in a second determined set of inputs or outputs, wherein the first determined set of inputs or outputs and the second determined set of inputs or outputs enable determinations of whether data relating to the interactive session is permitted to be outputted to the first user device or the second user device. Further, the method can include facilitating, by the processing system, the interactive session between the first user device and the second user device based on the first determined set of inputs or outputs and the second determined set of inputs or outputs.

Other embodiments are described in the subject disclosure.

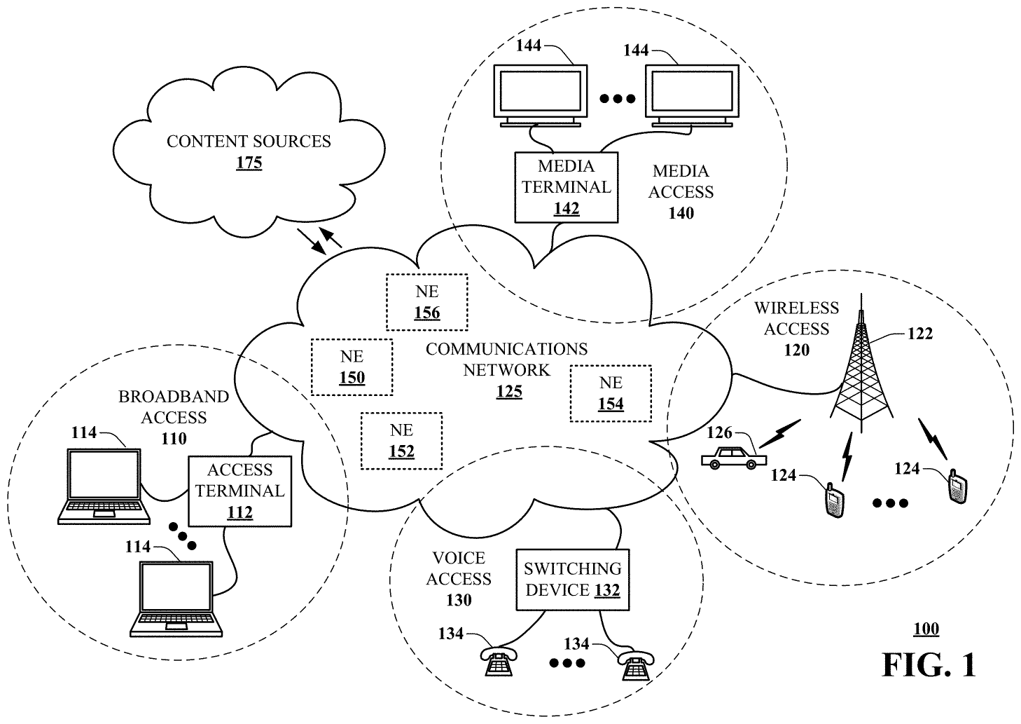

Referring now to FIG. 1, a block diagram is shown illustrating an example, non-limiting embodiment of a system 100 in accordance with various aspects described herein. For example, system 100 can facilitate, in whole or in part, determining of input(s) and/or output(s) for each of multiple user devices in an interactive session, and managing the interactive session between the user devices based on the determined input(s) and/or output(s). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

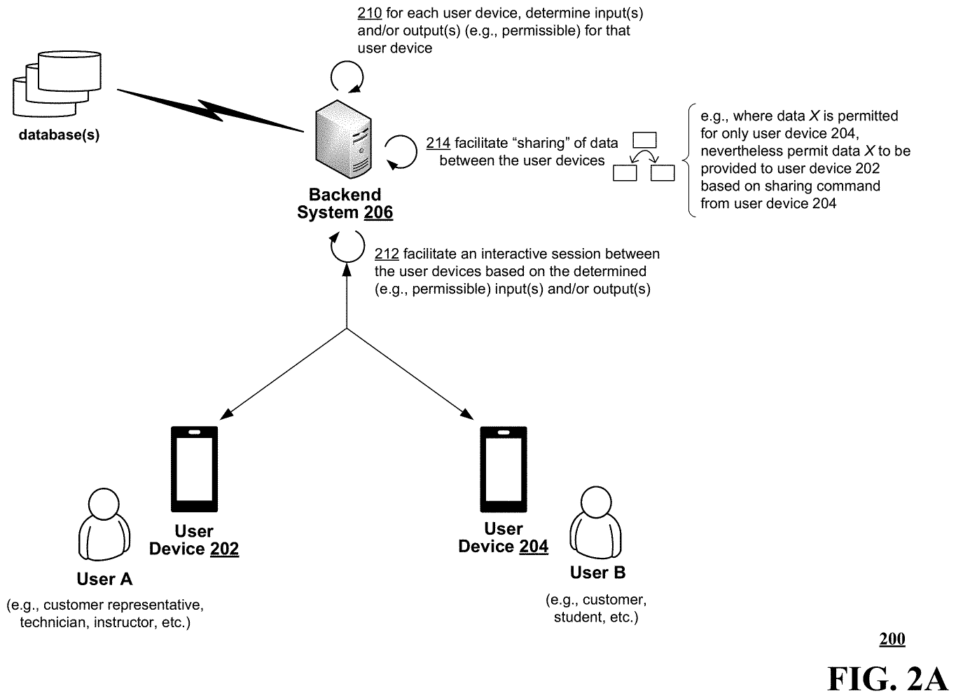

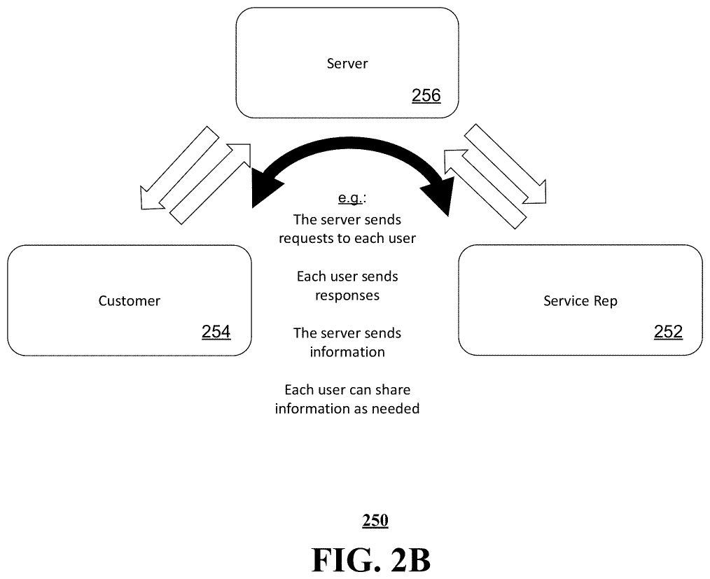

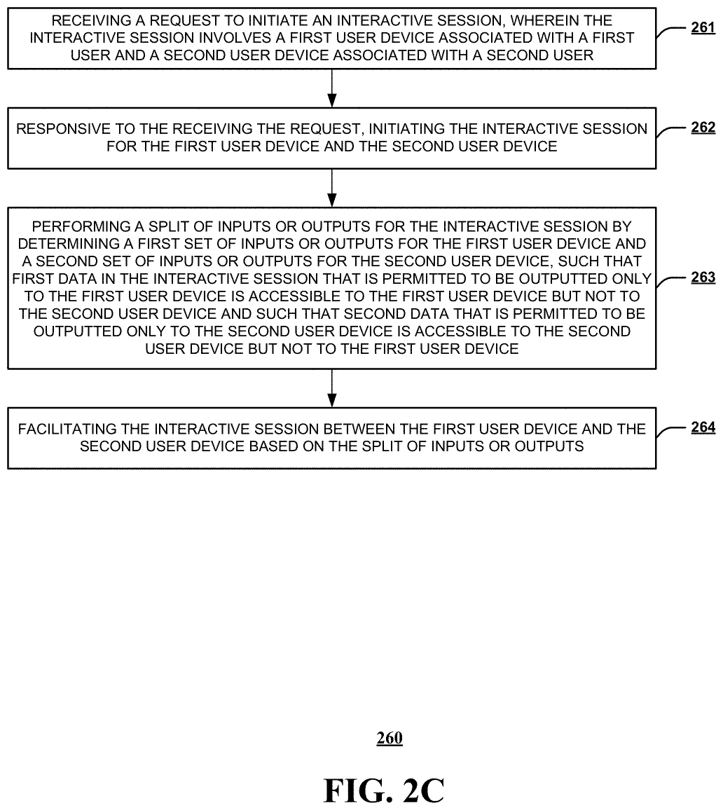

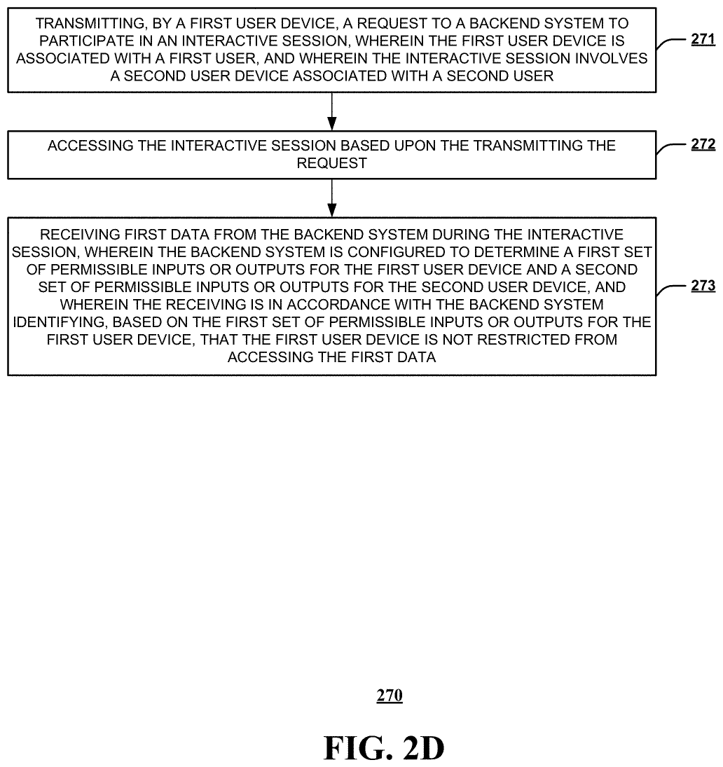

FIG. 2A is a block diagram illustrating an example, non-limiting embodiment of a split IO system 200 functioning within, or operatively overlaid upon, the communications network 100 of FIG. 1 in accordance with various aspects described herein. As shown in FIG. 2A, the split IO system 200 may include a user device 202, a user device 204, and a backend system 206. Each of the user devices 202 and 204 can include a communication device, such as a mobile phone (e.g., a smart phone, a radiotelephone, etc.), a wearable communication device (e.g., a smart wristwatch, a pair of smart eyeglasses, media-related gear (e.g., augmented reality (AR), virtual reality (VR), or mixed reality (MR) glasses and/or headset/headphones), etc.), a similar type of device, or a combination of some or all of these devices. As depicted in FIG. 2A, a user A may be associated with the user device 202, and a user B may be associated with the user device 204. In exemplary embodiments, the users A and B may engage in interactions using their respective user devices 202 and 204 over one or more sessions facilitated/managed by a system/service provider via the backend system 206. In various embodiments, the system/service provider may be associated with one or more of the user devices 202 and 204. For instance, in a customer service context (e.g., described in more detail below), the system/service provider may be a business entity associated with the user device 202, and the user device 204 may correspond to a customer. In alternate embodiments, the system/service provider may be a (e.g., trusted) third-party entity not associated/affiliated with users of the user devices 202 and 204, but that provides the split IO system 200 and/or the backend system 206 as a service to facilitate interactive sessions for the users.

The backend system 206 can include one or more devices (e.g., server device(s) or the like) configured to provide one or more functions or capabilities, such as, among other things, determining input(s) and/or output(s) for (e.g., each of) the user devices 202 and 204, and facilitating, and managing, interactive sessions between the user devices 202 and 204 based on the determined input(s) and/or output(s). In various embodiments, (e.g., each of) the user devices 202 and 204 may be configured to present (e.g., via a frontend application, via a web browser/application, or the like) a user interface (UI) associated with the split IO system 200 that facilitates user engagement in interactive sessions managed by the backend system 206.

Although not shown, in one or more embodiments, each of the user devices 202 and 204 may be communicatively coupled to the backend system 206 over one or more networks. Such network(s) may include one or more wired and/or wireless networks. For example, the network(s) may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

It is to be appreciated and understood that the types and quantities of the various devices/systems shown in FIG. 2A are merely exemplary. That is, the split IO system 200 may include any number of (e.g., more or fewer) user devices 202, user devices 204, and backend systems 206. For instance, the split IO system 200 may include multiple user devices 202, multiple user devices 204, multiple (e.g., separate or distributed) backend systems 206, one or more other devices, and so on.

As shown by reference number 210 of FIG. 2A, the backend system 206 may determine, for each of the user devices 202 and 204, input(s) and/or output(s) (e.g., permissible) for that user device, and as shown by reference number 212, the backend system 206 may facilitate an interactive session between the user devices 202 and 204 based on the determined input(s) and/or output(s). In various embodiments, the interactive session may enable interactions between the users A and B via their user devices 202 and 204.

In exemplary embodiments, the backend system 206 may determine (e.g., permissible) input(s) and/or output(s) for a user device based on predefined control data. In one or more embodiments, the predefined control data may identify information (e.g., stored in one or more local (or remote) databases) that may be needed or called upon during the session or that may be received in communication(s) from one or more of the user devices 202 and 204. The information can include any type of information, such as, for example, personal information associated with one or more users, account-related information, business-related information (e.g., marketing information, such as options/offers; product/service pricing information; etc.), educational content (e.g., problems, hints, answers, etc.), and so on. In certain embodiments, the predefined control data may also identify corresponding permission settings associated with one or more item(s) of the information. For instance, the predefined control data may identify certain item(s) of the information that are permitted to be accessible or outputted (e.g., only) to one of the users and/or item(s) of the information that are permitted to be accessible or outputted (e.g., only) to the other user. As another example, the predefined control data may identify certain item(s) of the information that are to be obtained or collected (e.g., only) from one of the users and/or item(s) of the information that are to be obtained or collected (e.g., only) from the other user. In various embodiments, some or all of the predefined control data may be set by a user (e.g., a system administrator or the like).

In one or more embodiments, the backend system 206 may receive request(s) from one or more of the user devices 202 and 204 to initiate/facilitate the interactive session, may provide session access information to one or more of the user devices 202 and 204 to enable access thereby to the session, and/or may authenticate one or more of the user devices 202 and 204 prior to permitting the user devices 202 and/or 204 to participate in the session.

As an example, a user device, such as the user device 202, may transmit a request to the backend system 206 to initiate/facilitate an interactive session. Here, the backend system 206 may process the request, initiate the session, and provide, to the user device 202, session access information (e.g., a reference number (such as a session name or ID, a service/order number, etc.), a uniform resource locator (URL), a Quick Response (QR) code, and/or the like) that another user device, such as the user device 204, may utilize to access the session. For instance, the backend system 206 may cause the user device 202 to present the session access information, which the user B of the user device 204 may utilize (e.g., by inputting the URL into a browser application of the user device 204 or scanning the QR code using the user device 204 to obtain a UI associated with the backend system 206, by inputting the reference number via the UI, and/or the like) to gain access to the session. Continuing the example, in embodiments where the backend system 206 is configured to perform user authentication/verification, the backend system 206 may request for and/or obtain authentication/verification information from the user device 202 (e.g., prior to or after receiving the request to initiate/facilitate the session) and/or may request for and/or obtain authentication/verification information from the user device 204 (e.g., after detecting a session access request from the user device 204).

Authentication/verification may be performed in any suitable manner, such as based upon input of a username/password combination, input of a personal identification number (PIN), user biometric data, and/or other data associated with the session, associated with the user (e.g., the user's name, phone number, etc.), and/or associated with the corresponding user device. For instance, a user (e.g., user A, user B, etc.) may input such information to the user's user device. In some embodiments, a user device (e.g., the user device 202, 204, etc.) may additionally, or alternatively, obtain (e.g., using an authentication app) other data relating to the user and/or the user device, such as SIM data stored in the user device or in a removeable SIM card, a serial number (e.g., an IMEI number or the like) associated with the user device, current and/or historical location data associated with the user device, data regarding a network access point to which the user device is currently and/or historically communicatively coupled, and/or the like. In any case, the user device may obtain user/device data (whether in the form of user inputs or other collected data), and may provide the user/device data to the backend system 206 for user authentication/verification.

In various embodiments, in a case where user/device data includes user-inputted information, such as a username, name, phone number, or the like, the backend system 206 may perform verification of the information to identify the user and/or the user device. In one or more embodiments, in a case where the user/device data additionally, or alternatively, includes other data collected by the authentication app of the user device, the backend system 206 may perform analyses and/or verification of that other data. For instance, in these embodiments, the backend system 206 may leverage an authentication system that provides authentication-related functionalities implemented in one or more server devices for facilitating mobile/user identity verification. Such an authentication system may include an authentication management server and a provider-based authentication server configured to communicate with one another as well as with respective authentication apps executing on user devices, such as the user devices 202 and 204. In one or more embodiments, each of the authentication apps may function as a device-side client of the overall authentication system. In certain embodiments, the provider-based authentication server may correspond to (e.g., may be operated or provided by) a network provider associated with the corresponding user device. In some embodiments, the authentication management server may coordinate with the provider-based authentication server to facilitate verification of a user or user device based on subscriber/device/account information. In various embodiments, a user of a user device (e.g., the user A of user device 202, the user B of user device 204, etc.) may (e.g., initially) register with the authentication management server and/or the provider-based authentication server, which may enable an authentication app on the user device to facilitate verification of the user device or the user when needed, such as when authentication/verification for participating in an interactive session is required. Registration may, for example, involve the provider-based authentication server (or a related system) enabling a setting in the user's subscriber account to permit utilization of the identity verification feature of the authentication system for the user and/or the user device. When registered, the authentication app on the user device may—e.g., in relation to accessing an interactive session—obtain information regarding the user and/or the user device (e.g., the user's name, SIM data stored in the user device, a device serial number (e.g., an International Mobile Equipment Identity (IMEI) number or the like), location data associated with the user device, data regarding a network access point to which the user device is communicatively coupled, biometric information associated with the user, and/or the like), and provide the information to the authentication management server and/or the provider-based authentication server for identity verification. Obtaining information regarding the user device and the user can provide for multi-factor authentication (i.e., 2 or more layers of protection) since, in such a case, both a user's data (e.g., login password, fingerprint, etc.) and device data (e.g., SIM data, IMEI number, etc.) could be used for authentication, which obviates device cloning issues. In this way, for example, a network provider can validate that a certain user device is indeed the user device (and not another user device) and/or that a user is indeed the user (and not another individual). This can provide enhanced authentication/verification of the user and/or the user device, since data regarding the current and/or historical location of the user device, SIM data associated with the user device, the IMEI number of the user device, the access points to which the user device is currently and/or historically communicatively coupled, and/or the like can enable a more reliable determination of user/device identity. In any case, where authentication/verification of a user and/or the associated user device is unsuccessful, the backend system 206 may deny the user/user device from accessing the session.

In some alternate embodiments, a session may be pre-established, and may be accessible to each of the user devices 202 and 204 via session access information. For example, the backend system 206 may create a (e.g., web-based) session that each of the user devices 202 and 204 may access via a URL, a QR code, or the like, may access based on input of other information (e.g., a service/order number, a session ID, a user's name, a user's phone number, etc.), and/or may access based on (e.g., the above-described) authentication/verification of (e.g., each of) the user devices and/or associated users.

Embodiments of the split IO system 200 may be employed in a variety of settings. For example, the split IO system 200 may be employed in a customer service context, such as in a case where a service representative or technician (e.g., user A of user device 202) visits the premises of a customer (e.g., user B of user device 204). In this context, the technician may not have a need to know certain personal information associated with the customer and/or the customer may not have a need to know certain business-related information associated with the product/service provider. For instance, the technician may not have a need to know the customer's full name, phone number, e-mail address, alternative addresses, birthdate, identification (e.g., social security) number, certain account-related information (e.g., balance due, payment history, payment method, etc.), information regarding other household members affiliated with the account, etc. Likewise, the customer may not have a need to know information regarding other product/service-related issues that the product/service provider has been experiencing, information regarding other customers who have experienced problems similar to the customer, tiers of product/service offerings and/or upgrades that the technician may upsell to the customer, tests that the technician can run to troubleshoot different issues, etc. Thus, here, the above-described predefined control data may identify item(s) of information that are permitted to be presented (e.g., only) to the technician and/or items of information that are permitted to be presented (e.g., only) to the customer. In this way, while the session may involve communications relating to the customer's personal information (e.g., for verification by the customer to ensure that the technician is at the correct premises, for account registration purposes if new service is being initiated, etc.), input(s) and/or output(s) relating to such personal information may pass (e.g., only) between the backend system 206 and the customer's user device (and not the technician's user device). Similarly, while the session may additionally, or alternatively, involve communications relating to business-related information (e.g., for guiding the technician's visit, for requesting external assistance during the visit, etc.), input(s) and/or output(s) relating to such business-related information may pass (e.g., only) between the backend system 206 and the technician's user device (and not the customer's user device). In various embodiments, and continuing the example, the predefined control data may identify item(s) of information that are permitted to be presented to both parties. Such information may include, for example, details regarding the session (e.g., time, date, issue or reason for the visit, etc.), how long the customer has had an account with the business, details regarding the product/service being addressed, and/or the like. FIG. 2B shows a block diagram of a non-limiting example implementation of a split IO system 250 for the abovementioned customer service context (where the server 256 may be the same as or similar to the backend system 206, the customer device 254 may be the same as or similar to the user device 204, and the service representative device 252 may be the same as or similar to the user device 202).

In the context of a technician visit to a customer's premises, and in a case where the technician needs access to the customer's home router for network connectivity, it would not be unreasonable for the customer to want to safeguard the router password/passphrase from the technician. For instance, the customer may utilize that password/passphrase elsewhere, and may worry that revealing it to the technician may compromise the user's other accounts or that the technician may return at a later time with other motives. Here, the backend system 206 may (e.g., based upon predefined control data) facilitate retrieval of the password/passphrase from (e.g., only) the customer's user device, and may cause the technician's user device to utilize that password/passphrase to connect to the router, all without outputting/presenting the actual password/passphrase on the technician's user device. In this example, the technician may utilize the UI on the technician's user device to submit a request (e.g., including a Service Set Identifier (SSID)) to the backend system 206 to access the customer's home router, and the backend system 206 may, based on this request, cause the customer's user device to prompt the customer for the router's password/passphrase. In various embodiments, the backend system 206 may also cause the customer's user device to present a notification indicating that the password/passphrase will not be stored or revealed to the technician. Responsive to the customer inputting the password/passphrase to the customer's user device, the password/passphrase may be transmitted (e.g., in encrypted form) to the backend system 206, and the backend system 206 may automatically trigger the technician's user device to connect to the customer's router using the obtained password/passphrase. In certain embodiments, the backend system 206 may, prior to, or as part of, terminating the session when the technician's visit is complete (e.g., upon detecting that the customer's user device and/or the technician's user device has requested to exit or log off from the session), cause the technician's user device to delete or otherwise “forget” the customer's router information so as to prevent the technician's user device from further accessing the customer's home network. In certain embodiments, the backend system 206 may additionally provide a notification to the customer's user device regarding this deletion, which can provide comfort to the customer that the password/passphrase will not be misused, and that the technician no longer has access to the customer's router.

Embodiments of the split IO system 200 can enable trusted splits of input(s) and output(s) in a variety of other scenarios. For example, in an in-store customer service context, the backend system 206 may facilitate a customer service engagement by guiding a store employee (e.g., via prompts presented on the employee's user device) with hint(s) regarding what's presented on the customer's user device. For instance, where certain personal information of the customer needs to be verified (e.g., the customer's phone number), the backend system 206 may cause the customer's user device to prompt the customer to input that information, and may cause the store employee's user device to present a hint, such as “Please enter your phone number—the main one on the account ending in *5555” or the like, which can enable the store employee to guide the customer through the process. Here, based upon verification of the customer, the backend system 206 may, for instance, provide account-related information (e.g., their monthly bill, etc.) to the customer's user device for the customer to review, without necessarily providing the same to the store employee's user device.

As another example, in a classroom (e.g., online learning) context in which problem solving is involved, there may be answers to questions that should not be revealed to a student while the student is working on the problems. Here, the backend system 206 may facilitate the session by, for instance, permitting questions, any possible answer choices, and the actual answers to be provided to the instructor's user device, and permitting only the questions and any possible answers choices, but not the actual answers, to be provided to the student's user device.

In certain embodiments, the backend system 206 may additionally, or alternatively, employ one or more AI algorithms (e.g., machine learning model(s)) to determine input(s) and/or output(s) that are permissible for (e.g., each of) the user devices 202 and 204. In these embodiments, the AI algorithm(s) may pre-classify (e.g., each) item of information stored in the local (or remote) database(s), classify other data that may be communicated by the user devices 202 and 204, determine the appropriate input(s) and/or output(s) for the user devices 202 and 204 based on the pre-classifications and/or classifications, and facilitate the session based on the determination. For instance, the AI algorithm(s) may analyze information/data and determine (e.g., based on prior learnings or prior user (e.g., administrator) inputs) whether to classify that information/data as being permissible for one or more of the user devices 202 and 204. As an example, in the above-described customer service context, the AI algorithm(s) may, based upon receiving a communication from the user device 204 determined to include personal information, such as a name, address, etc., classify the personal information as “sensitive” personal information, and may refrain from providing that information to the user device 202 but permit it to be accessible to the user device 204 (e.g., for later verification). As another example, in the above-described customer service context, the AI algorithm(s) may, based upon obtaining (e.g., from a database, etc.) an item of information determined to include business-related data, such as marketing strategies, product issues, etc., classify that information as “sensitive” business information, and may refrain from providing that information to the user device 204 but permit it to be accessible to the user device 202. In this way, the backend system 206 may (e.g., in real-time or near real-time and with or without a need to consult predefined control data, such as that described above) dynamically determine input(s) and/or output(s) for the user devices 202 and 204 and facilitate the session accordingly.

As shown by reference number 214 of FIG. 2A, the backend system 206 may facilitate “sharing” of data between the user devices 202 and 204. In exemplary embodiments, this may involve permitting data, that is previously determined to be accessible (e.g., only) to one of the user devices 202 and 204, to now be accessible to the other of the user devices as well. In various embodiments, the backend system 206 may enable sharing of information with certain user devices during an interactive session. In one or more embodiments, the backend system 206 may enable such sharing based on a user instruction/setting, based on a determination that the data is not to be treated as, e.g., sensitive to either party, based on a threshold time being reached, and/or the like. For instance, in a case where data X is previously determined (e.g., based on predefined control data, based on one or more AI models, etc.) to be accessible only to user device 204, and the user device 204 (e.g., responsive to receiving an instruction from user B) submits a sharing command to enable sharing of data X with the user device 202, the backend system 206 may permit data X to be accessible/provided to the user device 202.

As an example, in a customer service context where certain product offering information is (e.g., initially) restricted from being outputted to the user device 204 (e.g., the customer), if the backend system 206 receives a user instruction from the user device 202 to share the product offering information with the user device 204, the backend system 206 may nevertheless permit such information to be accessible/provided to the user device 204.

As another example, in a case where the backend system 206 employs AI algorithm(s) for facilitating a session, the AI algorithm(s) may—e.g., based upon monitoring and analysis of communications between the user devices 202 and 204, based upon monitoring and analysis of captured video or audio of an in-person exchange between the users A and B, such as during a live interaction between the users, and/or the like—determine that certain data (e.g., initially) restricted from one of the users should now instead be accessible to that user. In various embodiments, the AI algorithm(s) may perform such determinations based on one or more thresholds being satisfied and/or based on identifying a certain context or certain circumstances during the communications/exchanges. For instance, in an in-person customer service context, and in a case where the customer's name or phone number is (e.g., based on predefined control data, based on one or more AI models, etc.) initially accessible to the customer's user device 204, but not to the service representative's user device 202, the AI algorithm(s) may, based upon detecting (e.g., from captured audio of the in-person exchange) the customer's utterance of the customer's name or phone number to the service representative, determine that such information is no longer sensitive during the session, and subsequently permit that information to be accessible to the service representative's user device 202.

In some embodiments, the backend system 206 may, responsive to receiving a sharing command from a user device or based upon determining (e.g., via AI algorithm(s)) to share certain data/information, prompt a user (e.g., the user who submitted the sharing command or who may be negatively impacted if the data/information were shared with the other party) to verify/confirm that the information is indeed shareable. Confirmation prior to enabling sharing can avoid inadvertent exposure to sensitive data. Here, the backend system 206 may refrain from sharing the data/information unless it receives the appropriate user confirmation.

As a further example, in a classroom (e.g., online learning) context, an instructor may desire to guide a student during problem-solving by providing select hint(s) to the student along the way. Here, for instance, the backend system 206 may, based upon receiving a command from the instructor's device to share a hint with the student's device, cause the hint to be presented on the student's device.

Accordingly, embodiments of the split IO system 200 may determine whether to make certain information (obtained from database(s) for the session or received from one or more of the user devices 202 and 204 during the session) accessible to either of the user devices 202 and 204 (e.g., to only one of these devices) or to both of the devices.

While the manner of facilitating sessions between user devices has been described above as being through the use of a (e.g., split IO system-based) UI on the user devices, in certain alternate embodiments, the split IO system 200 may facilitate an interactive session in other ways, such as, for example, via exchanges of text-based messages, video-based messages, audio-based messages, or haptic-based messages with one or more of the user devices 202 and 204. For instance, in the context of a customer service engagement, and in a case where text messaging is used for the session, the backend system 206 may exchange text messages with user devices 202 and/or 204, and control the exchanges based on the above-described input(s) and/or output(s) determined for the two devices. Here, if the customer texts certain personal information, such as, for example, the customer's name or phone number, to the backend system 206, the backend system 206 may, similarly to that described above, prevent such information from being texted to the customer service representative's device. As another example, if the customer service representative texts a command to the backend system 206 to share certain business-related information (e.g., product offerings, etc.) with the customer, the backend system 206 may permit such information to be texted to the customer's device.

It is to be understood and appreciated that the quantity and arrangement of systems and devices shown in FIG. 2A are provided as an example. In practice, there may be additional systems and/or devices, or differently arranged systems and/or devices than those shown in FIG. 2A. For example, the split IO system 200 can include more or fewer systems and/or devices, etc. In practice, therefore, there can be hundreds, thousands, millions, billions, etc. of such systems and/or devices. In this way, example system 200 can coordinate, or operate in conjunction with, a set of systems and/or devices and/or operate on data sets that cannot be managed manually or objectively by a human actor. Furthermore, two or more systems or devices shown in FIG. 2A may be implemented within a single system or device, or a single system or device shown in FIG. 2A may be implemented as multiple systems or devices. Additionally, or alternatively, a set of systems or devices of the system 200 may perform one or more functions described as being performed by another set of systems or devices of the system 200.

While for purposes of simplicity of explanation, the respective processes are shown and described as various steps in FIG. 2A, it is to be understood and appreciated that the claimed subject matter is not limited by the order of the steps, as some steps may occur in different orders and/or concurrently with other steps from what is depicted and described herein. Moreover, not all illustrated steps may be required to implement the methods described herein.

FIG. 2C depicts an illustrative embodiment of a method 260 in accordance with various aspects described herein. In some embodiments, one or more process blocks of FIG. 2C can be performed by a backend system, such as the backend system 206.

At 261, the method can include receiving a request to initiate an interactive session, wherein the interactive session involves a first user device associated with a first user and a second user device associated with a second user. For example, the backend system 206 can, similar to that described elsewhere herein, perform one or more operations that include receiving a request to initiate an interactive session. The interactive session may involve a first user device associated with a first user and a second user device associated with a second user.

At 262, the method can include, responsive to the receiving the request, initiating the interactive session for the first user device and the second user device. For example, the backend system 206 can, similar to that described elsewhere herein, perform one or more operations that include, responsive to the receiving the request, initiating the interactive session for the first user device and the second user device.

At 263, the method can include performing a split of inputs or outputs for the interactive session by determining a first set of inputs or outputs for the first user device and a second set of inputs or outputs for the second user device, such that first data in the interactive session that is permitted to be outputted only to the first user device is accessible to the first user device but not to the second user device and such that second data that is permitted to be outputted only to the second user device is accessible to the second user device but not to the first user device. For example, the backend system 206 can, similar to that described elsewhere herein, perform one or more operations that include performing a split of inputs or outputs for the interactive session by determining a first set of inputs or outputs for the first user device and a second set of inputs or outputs for the second user device, such that first data in the interactive session that is permitted to be outputted only to the first user device is accessible to the first user device but not to the second user device and such that second data that is permitted to be outputted only to the second user device is accessible to the second user device but not to the first user device.

At 264, the method can include facilitating the interactive session between the first user device and the second user device based on the split of inputs or outputs. For example, the backend system 206 can, similar to that described elsewhere herein, perform one or more operations that include facilitating the interactive session between the first user device and the second user device based on the split of inputs or outputs.

In some implementations of these embodiments, the performing the split of inputs or outputs causes third data in the interactive session, that is permitted to be outputted to both the first user device and the second user device, to be accessible to both the first user device and the second user device.

In some implementations of these embodiments, the determining the first set of inputs or outputs and the second set of inputs or outputs is based on predefined control data or involves use of one or more artificial intelligence (AI) models.

In some implementations of these embodiments, the interactive session relates to a customer service engagement, the first user comprises a customer service representative, and the second user comprises a customer. In some implementations of these embodiments, the first data comprises business-related information. In some implementations of these embodiments, the second data comprises customer personal information.

In some implementations of these embodiments, the interactive session relates to an educational engagement, the first user comprises an instructor, and the second user comprises a student.

In some implementations of these embodiments, the method may further comprise, during the facilitating the interactive session, receiving a first command from the first user device to enable sharing of at least a portion of the first data with the second user device, and based on the receiving the first command, permitting the at least a portion of the first data to be outputted to the second user device.

In some implementations of these embodiments, the method may further comprise, during the facilitating the interactive session, receiving a second command from the second user device to enable sharing of at least a portion of the second data with the first user device, and based on the receiving the second command, permitting the at least a portion of the second data to be outputted to the first user device.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2D depicts an illustrative embodiment of a method 270 in accordance with various aspects described herein. In some embodiments, one or more process blocks of FIG. 2D can be performed by a user device, such as the user device 202 or the user device 204.

At 271, the method can include transmitting, by a first user device, a request to a backend system to participate in an interactive session, wherein the first user device is associated with a first user, and wherein the interactive session involves a second user device associated with a second user. For example, the user device can, similar to that described elsewhere herein, perform one or more operations that include transmitting a request to a backend system to participate in an interactive session. The user device may be a first user device that is associated with a first user, and the interactive session may involve a second user device associated with a second user.

At 272, the method can include accessing the interactive session based upon the transmitting the request. For example, the user device can, similar to that described elsewhere herein, perform one or more operations that include accessing the interactive session based upon the transmitting the request.

At 273, the method can include receiving first data from the backend system during the interactive session, wherein the backend system is configured to determine a first set of permissible inputs or outputs for the first user device and a second set of permissible inputs or outputs for the second user device, and wherein the receiving is in accordance with the backend system identifying, based on the first set of permissible inputs or outputs for the first user device, that the first user device is not restricted from accessing the first data. For example, the user device can, similar to that described elsewhere herein, perform one or more operations that include receiving first data from the backend system during the interactive session. The backend system may be configured to determine a first set of permissible inputs or outputs for the first user device and a second set of permissible inputs or outputs for the second user device, and the receiving may be in accordance with the backend system identifying, based on the first set of permissible inputs or outputs for the first user device, that the first user device is not restricted from accessing the first data.

In some implementations of these embodiments, the method may further comprise submitting second data to the backend system during the interactive session, where the backend system controls whether the second data is accessible to the second user device based on the second set of permissible inputs or outputs for the second user device.

In some implementations of these embodiments, the interactive session relates to an educational engagement, the first user comprises a student, and the second user comprises an instructor.

In some implementations of these embodiments, third data is excluded from the first set of permissible inputs or outputs, the method may further comprise receiving the third data from the backend system during the interactive session despite the third data being excluded from the first set of permissible inputs or outputs, and the receiving the third data may be in accordance with a user command, transmitted from the second user device to the backend system, to permit the third data to be accessible to the first user device. In some implementations of these embodiments, the third data comprises one or more hints to one or more problems presented by the first user device during the interactive session.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

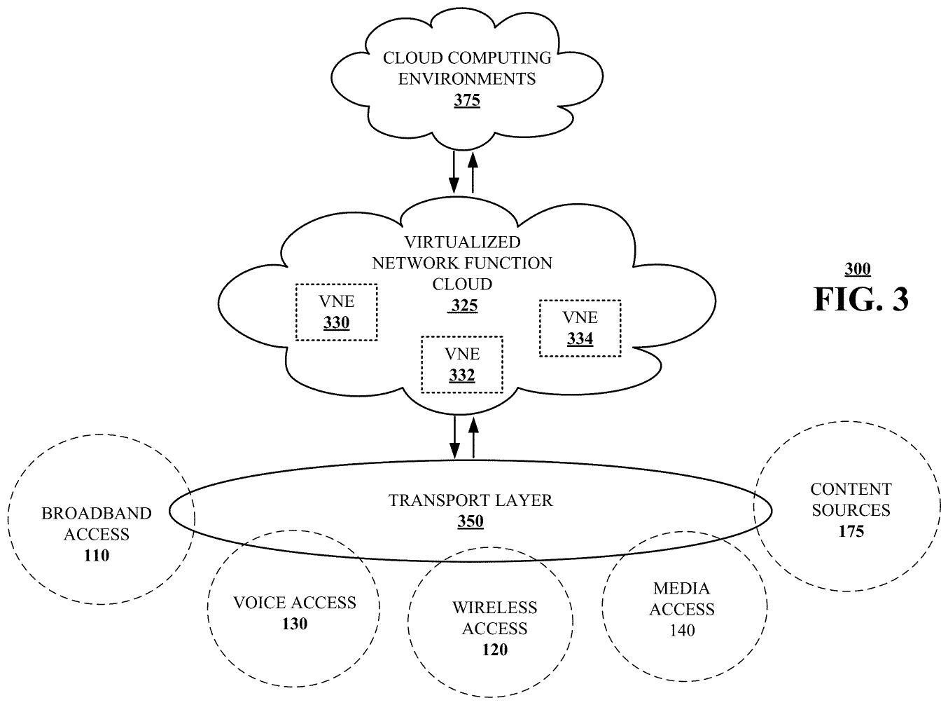

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, system 250, method 260, and method 270 presented in FIGS. 1 and 2A-2D. For example, virtualized communications network 300 can facilitate, in whole or in part, determining of input(s) and/or output(s) for each of multiple user devices in an interactive session, and managing the interactive session between the user devices based on the determined input(s) and/or output(s).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

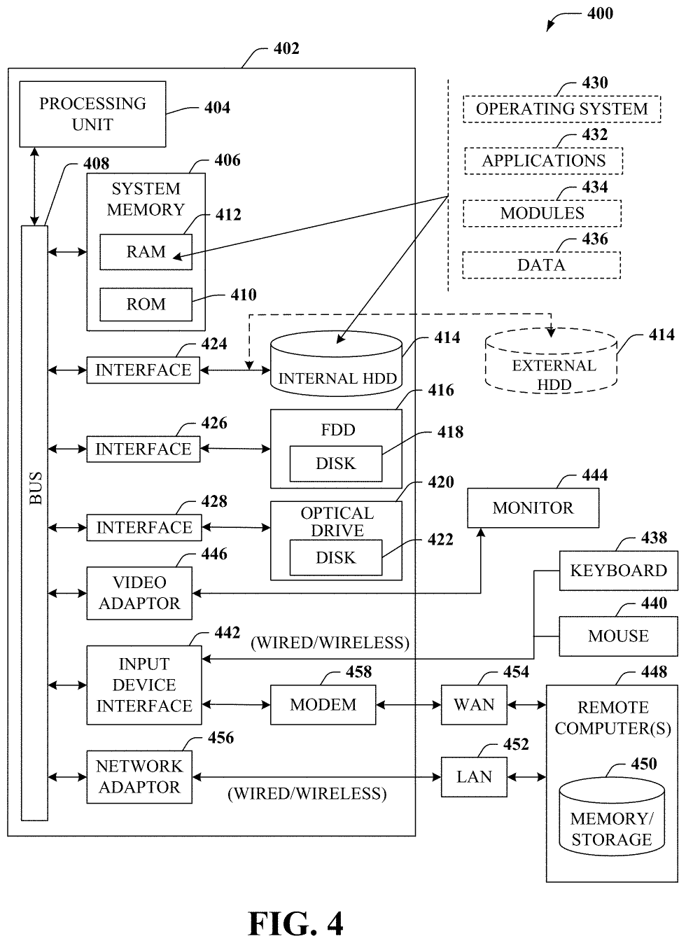

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, determining of input(s) and/or output(s) for each of multiple user devices in an interactive session, and managing the interactive session between the user devices based on the determined input(s) and/or output(s).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

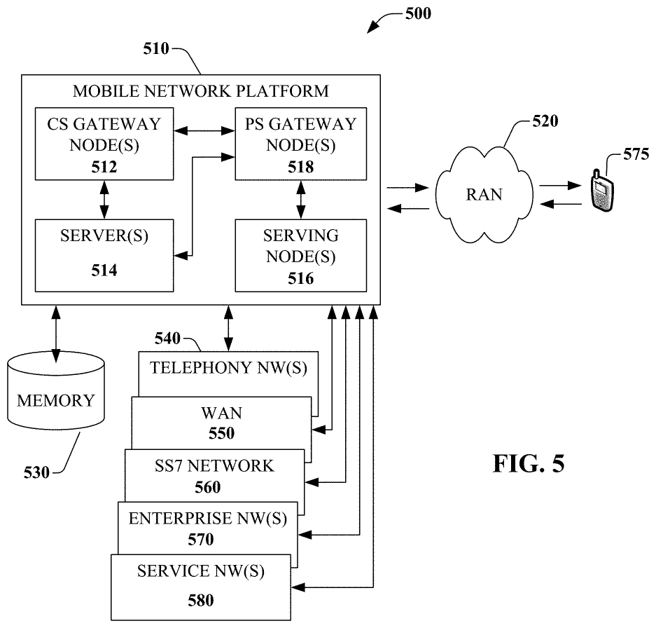

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, determining of input(s) and/or output(s) for each of multiple user devices in an interactive session, and managing the interactive session between the user devices based on the determined input(s) and/or output(s). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

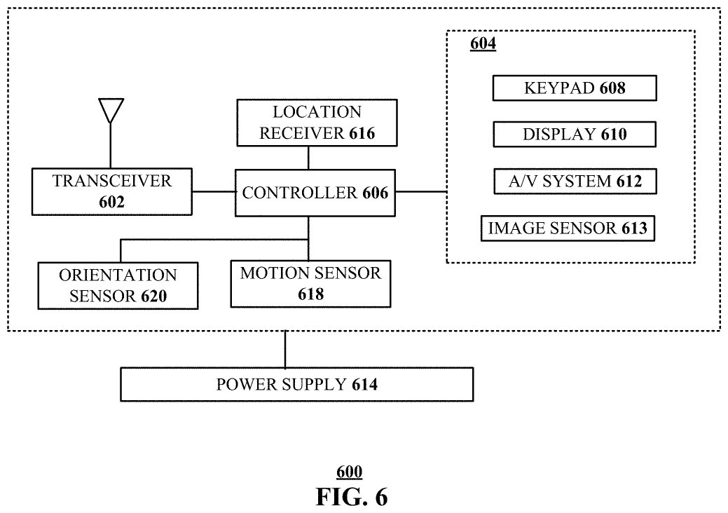

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate, in whole or in part, determining of input(s) and/or output(s) for each of multiple user devices in an interactive session, and managing the interactive session between the user devices based on the determined input(s) and/or output(s).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
receiving a request to initiate an interactive session, wherein the interactive session involves a first user device associated with a first user and a second user device associated with a second user;
responsive to the receiving the request, initiating the interactive session for the first user device and the second user device;
determining a first set of first data comprising permissible inputs or outputs for the first user device and a second set of second data comprising permissible inputs or outputs for the second user device, based on predefined control data, wherein the first data is accessible to the first user device but not to the second user device and the second data is accessible to the second user device but not to the first user device, and wherein the control data identifies information stored in one or more databases for use in the interactive session; and
facilitating the interactive session between the first user device and the second user device in accordance with the control data, wherein the facilitating further comprises causing the first user device to present session access information for use by the second user device to access the interactive session.

2. The device of claim 1, wherein the facilitating further comprises causing third data in the interactive session to be accessible to both the first user device and the second user device.

3. The device of claim 1, wherein the determining the first set of first data and the second set of second data involves use of one or more artificial intelligence (AI) models.

4. The device of claim 1, wherein the processing system and the memory are located at a backend of a network.

5. The device of claim 1, wherein the interactive session relates to a customer service engagement, wherein the first user comprises a customer service representative, and wherein the second user comprises a customer.

6. The device of claim 5, wherein the first data comprises business-related information.

7. The device of claim 6, wherein the second data comprises customer personal information.

8. The device of claim 1, wherein the interactive session relates to an educational engagement, wherein the first user comprises an instructor, and wherein the second user comprises a student.

9. The device of claim 1, wherein the operations further comprise, during the facilitating the interactive session, receiving a first command from the first user device to enable sharing of at least a portion of the first data with the second user device, and based on the receiving the first command, permitting the at least a portion of the first data to be accessible to the second user device.

10. The device of claim 1, wherein the operations further comprise, during the facilitating the interactive session, receiving a second command from the second user device to enable sharing of at least a portion of the second data with the first user device, and based on the receiving the second command, permitting the at least a portion of the second data to be accessible to the first user device.

11. A non-transitory machine-readable medium, comprising executable instructions that, when executed by a processing system of a first user device including a processor, facilitate performance of operations, the operations comprising:
transmitting a request to a backend system to participate in an interactive session, wherein the first user device is associated with a first user, and wherein the interactive session involves a second user device associated with a second user;
accessing the interactive session based upon the transmitting the request; and
receiving data from the backend system during the interactive session, wherein the backend system is configured to determine a first set of first data comprising permissible inputs or outputs for the first user device and a second set of second data comprising permissible inputs or outputs for the second user device, based on predefined control data, wherein the receiving is in accordance with the backend system identifying, based on the first set of first data, that the first user device is not restricted from accessing the data, wherein the control data identifies information stored in one or more databases for use in the interactive session, wherein the backend system facilitates the interactive session in accordance with the control data, and wherein the backend system causes the first user device to present session access information for use by the second user device to access the interactive session.

12. The non-transitory machine-readable medium of claim 11, wherein the operations further comprise submitting additional data to the backend system during the interactive session, and wherein the backend system controls whether the additional data is accessible to the second user device based on the second set of permissible inputs or outputs for the second user device.

13. The non-transitory machine-readable medium of claim 11, wherein the interactive session relates to an educational engagement, wherein the first user comprises a student, and wherein the second user comprises an instructor.

14. The non-transitory machine-readable medium of claim 13, wherein third data is excluded from the first set of first data, wherein the operations further comprise receiving the third data from the backend system during the interactive session despite the third data being excluded from the first set of first data, and wherein the receiving the third data is in accordance with a user command, transmitted from the second user device to the backend system, to permit the third data to be accessible to the first user device.

15. The non-transitory machine-readable medium of claim 14, wherein the third data comprises one or more hints to one or more problems presented by the first user device during the interactive session.

16. A method, comprising:
obtaining, by a processing system including a processor, and from a first user device associated with a first user and a second user device associated with a second user, respective requests to access an interactive session;
based upon the obtaining the respective requests, initiating, by the processing system, the interactive session for the first user device and the second user device;
identifying, by the processing system in accordance with predefined control data, a first set of first data comprising permissible inputs or outputs for the first user device, and identifying, by the processing system, a second set of second data comprising permissible inputs or outputs for the second user device, wherein the first set of first data and the second set of second data enable determinations of whether data relating to the interactive session is permitted to be accessible to the first user device or the second user device, wherein the control data identifies information stored in one or more databases for use in the interactive session; and
facilitating, by the processing system in accordance with the predefined control data, the interactive session between the first user device and the second user device based on the first set of first data and the second set of second data, wherein the facilitating further comprises causing the first user device to present session access information for use by the second user device to access the interactive session.

17. The method of claim 16, wherein one or more of the respective requests are obtained based on the first user device or the second user device accessing a uniform resource locator (URL) or Quick Response (QR) code associated with the processing system.

18. The method of claim 16, wherein the processing system is located at a backend of a network.

19. The method of claim 16, wherein the identifying the first set of first data and the identifying the second set of second data involve use of one or more artificial intelligence (AI) models.

20. The method of claim 16, wherein the facilitating the interactive session is via text messaging, video messaging, audio-based messaging, haptic-based messaging, or one or more combinations thereof.
